(19) United States
(12) Patent Application Publication
(10) Pub. No.: US 2002/0160256 A1
(43) Pub. Date: Oct. 31, 2002

(54) Non-aqueous electrolyte secondary battery

(76) Inventors: Kenichiro Kami, Takahama-city (JP); Hiroshi Ueshima, Anjo-city (JP); Ryuichirou Shinkai, Kariya-city (JP); Norikazu Hosokawa, Nagoya-city (JP); Manabu Yamada, Okazaki-city (JP); Hideo Amaki, Handa-city (JP); Tomoaki Tamura, Takahama-city (JP)

Correspondence Address: LAW OFFICE OF DAVID G POSZ, 2000 L STREET, N.W., SUITE 200, WASHINGTON, DC, 20036, US

(21) Appl. No.: 09/944,150

(22) Filed: Sep. 4, 2001

(30) Foreign Application Priority Data
Sep. 21, 2000 (JP) 2000-287145
May 15, 2001 (JP) 2001-145341

(51) Int. Cl. H01M 6/00; H01M 10/00

(52) U.S. Cl. 429/122

(57) ABSTRACT

A method of fabricating a porous film of a non-aqueous electrolyte secondary battery and a method of fabricating the electrode of a non-aqueous electrolyte secondary battery by which a highly safe and inexpensive non-aqueous electrolyte secondary battery can be produced, and a highly safe and inexpensive non-aqueous electrolyte secondary battery are disclosed. The method of fabricating the electrode of a non-aqueous electrolyte secondary battery according to the invention comprises the steps of forming an electrode plate providing a positive electrode or a negative electrode of a non-aqueous electrolyte secondary battery and forming and attaching a porous film of a polymer material on the surface of the electrode plate thereby to produce the electrode plate having the porous film on the surface thereof. The step of attaching a porous film includes the step of modifying at least a portion of the porous film by bonding a predetermined substituent different from the group contained in the polymer material to the carbon atoms of the backbone chain of the polymer material through two or more successive carbon atoms in the predetermined substituent after the porous film forming step.

### BACKGROUND OF THE INVENTION

1. Field of the Invention

The present invention relates to a porous film for a non-aqueous electrolyte secondary battery, a method of fabricating the same secondary battery, an electrode for a non-aqueous electrolyte secondary battery and a method of fabricating the same electrode, and a non-aqueous electrolyte secondary battery using the same electrode for the non-aqueous electrolyte secondary battery.

2. Description of the Related Art

In recent years, vigorous efforts have been made to develop a high-performance secondary battery as a clean energy source for notebook-size computers, miniature portable equipment and automobiles. The secondary battery used for these purposes is required to be compact and light in weight but have a large capacity and a high output, i.e. to have a high energy density and a high output density. Also, the need of storing a large amount of energy makes it critical to secure safety. A promising secondary battery for achieving a high energy density and a high output density is a non-aqueous electrolyte secondary battery such as a lithium secondary battery.

The lithium secondary battery includes a positive electrode capable of intercalating and releasing lithium ions, a negative electrode capable of occluding and releasing lithium ions released from the positive electrode, a porous separator interposed between the positive and negative electrodes, and an electrolyte for moving lithium ions between the positive and negative electrodes.

The lithium secondary battery which has a wide range operating electrical potential assumes a highly reduced state on the negative electrode side and a highly oxidized state on the positive electrode side thereof.

The separator composed of polyethylene, polypropylene or polyolefin in current use has a superior resistance to reduction and a superior resistance to oxidization but insufficient heat resistance. At a high temperature exceeding 150° C., for example, the shutdown function fails to work, and condensation or film breakage is known to cause shorting. The low heat resistance of the separator makes it impossible to dry the separator and the electrodes at high temperatures after being assembled to form a secondary battery, and therefore the electrodes and the separator are required to be assembled in a dry room. Another problem is that the separator has an oxygen index so low that it is liable to burn at high temperatures. Further, in view of the need of complicated processes such as the extension step and the extraction of the solvent and the additive for achieving the porosity of the polyolefin separator, the separator cost increases and represents a considerable percentage of the whole cost of the secondary battery.

Methods available for fabricating a low-cost porous film include the solvent cast method in which a polymer is dissolved in a solvent to make a polymer solution at a normal or a high temperature and, after being coated (by solvent casting) on a base member such as an electrode plate, the assembly is cooled or dipped in a poor solvent of the particular polymer to deposit and dry the resin, and the hot-melt method in which the polymer is dissolved at high temperature and after being coated on the base member such as an electrode plate, cooled and solidified.

Nevertheless, due to a strong demand for a high energy density, a high output density and an improved safety of the non-aqueous electrolyte secondary battery, the non-aqueous electrolyte secondary battery contains various compounds. Some of these non-aqueous electrolytes swell or dissolve the separator. The separator, therefore, is required to have a high resistance to the electrolyte, especially at high temperatures.

Many polymers to which the solvent cast method or the hot-melt method is readily applicable are comparatively low molecular weight. Such polymers have insufficient resistance to specific electrolytes at high temperatures and hence have insufficient life and safety.

With polyester, polyimide, etc. which, being high in molecular weight, have a heat resistance and a resistance to electrolytes, on the other hand, a poreless film can be mass produced, but a uniform microporous film is difficult to form. A porous film using a nonwoven fabric composed of these polymers is also available. Such a porous film, however, cannot be easily reduced in thickness, has a comparatively large and uneven pore diameter with a large resistance, and a comparatively low resistance to reduction or oxidization. For this reason, the separator is often swollen or decomposed in operation and the increased internal resistance poses the problem of a shorter life of the secondary battery.

An attempt to produce a porous film by casting a polymer solution constituted of a mixture of a polymer, a crosslinking agent and an organic peroxide with the intention of improving the resistance to electrolytes, on the other hand, causes the decomposition of the organic peroxide due to the heat generated during the preparation of the polymer solution and the resultant reaction between the crosslinking agent and the polymer leads to an increased viscosity (scorch) of the polymer solution. A further progress of this reaction often sets the polymer solution and makes it impossible to prepare a stable porous film.

Further, during the charge operation, the portion having both a positive electrode composite material and a negative electrode composite material causes a charge exchange between Li ions and electrons of the negative electrode so that excessive electrons are rare on the negative electrode, whereas the position having no positive electrode composite material and having a negative electrode composite material, on the other hand, causes excessive electrons on the negative electrode due to a small number of Li ions exchanging the charge with electrons, resulting in a strong reduction atmosphere. Thus, a shortage of the reduction resistance of the separator causes the swelling or dissolution of the material constituting the separator, thereby leading to the problem of an increased internal resistance or an increased self-discharge for a lower secondary battery durability. Also, when the secondary battery is overcharged, a highly reducible Li is liable to be deposited. It has thus been found, therefore, that reduction resistance is required of the separator.

### SUMMARY OF THE INVENTION

Accordingly, an object of the present invention is to provide a porous film for a non-aqueous electrolyte secondary battery and a method of fabricating the porous film with which a non-aqueous electrolyte secondary battery high in safety and low in cost can be produced.

Another object of the invention is to provide an electrode for a non-aqueous electrolyte secondary battery and a method of fabricating an electrode with which a safe, inexpensive non-aqueous electrolyte secondary battery can be produced.

Still another object of the invention is to provide a safe, inexpensive non-aqueous electrolyte secondary battery.

In order to achieve the objects mentioned above, the inventors have made a vigorous effort and achieved the following invention.

Specifically, according to a first aspect of the invention, there is provided a method of fabricating a porous film of a non-aqueous electrolyte secondary battery, comprising the steps of forming a porous film composed of a polymer material, and modifying at least a part of the porous film by bonding a predetermined substituent different from the group contained in the polymer material to the carbon atoms of the backbone chain of the polymer material through two or more successive carbon atoms in the predetermined substituent.

More specifically, in the method of fabricating a porous film of a non-aqueous electrolyte secondary battery according to the invention, the porous film having the function as a separator is changed to a composition having the property easy to handle in the porous film forming step, after which the substituent is introduced into the polymer material which thus becomes insoluble in the electrolyte when actually used in the non-aqueous electrolyte secondary battery. In this way, both the function as a separator having a resistance to the electrolyte and a high productivity of the separator can be achieved at the same time.

In the method of fabricating a porous film for a non-aqueous electrolyte secondary battery according to the invention, therefore, it is possible to provide a porous film for a non-aqueous electrolyte secondary battery which can produce a highly safe, inexpensive non-aqueous electrolyte secondary battery. Incidentally, the wording “bonded to the carbon atoms of the backbone chain of the polymer material through two or more successive carbon atoms” in the present specification indicates that the polymer of the polymer material and the predetermined substituent are bonded to each other not by ester linkage or ether linkage but by covalent bond. In the case of the ester linkage with the —COOH group on the polymer backbone chain (—COOR), for example, two or more successive carbon atoms are not bonded with the polymer backbone chain (only one carbon atom).

In the modification step, a modifier having the predetermined substituent of one to 100 parts by mass is preferably made to react with the polymer material having 100 parts by mass constituting the porous film.

A modifier having a substituent of fewer parts by mass would cause a less change of the properties of the polymer material before and after modification, while a modifier having a substituent of greater parts by mass makes it difficult to change the properties. The function or the productivity of the separator, therefore, is sufficiently high within this range of parts by mass.

Further, the porous film forming step preferably uses a mixture material of the polymer material and a modifier having the predetermined substituent.

The electrode can be fabricated easily by using a mixed material of a polymer material and a modifier.

The modification step includes the coating step for coating a modifier having the predetermined substituent on the surface of the porous film, and preferably, the predetermined substituent of the modifier or the backbone chain of the polymer material is bonded with the predetermined substituent after the coating step.

Also, the modification step includes the step of radiating a high energy beam on the porous film for bonding the predetermined substituent and the backbone chain to the predetermined substituent.

The high energy beam radiation can be carried out even in solid phase reaction and requires no post-processing, and thus simplifies the process. Another advantage is that the modification reaction can be carried on without any agent such as an organic peroxide. Also, even in the case where the modifier has no polymerization group, the predetermined substituent can be introduced by optimizing the reaction conditions.

The modification step preferably includes the initiator for bonding coating step for coating a bonding start agent for starting the bonding between the predetermined substituent or the backbone chain and the predetermined substituent by heating the porous film, and the heating step for heating the porous film.

In view of the fact that the initiator is coated after forming the porous film, the gelation of the polymer material fails to proceed at the time of forming a porous plate, and therefore the step of forming the porous film can be carried out more easily while at the same time making it possible to change the properties of the polymer material, positively, in the modification step.

Further, the modifier preferably contains at least one type of compound having one or more polymerization groups. The polymerization group has preferably an unsaturated multiple bond.

The unsaturated multiple bond can easily bond the modifier to a polymer material forming the porous film by radical reaction.

The modifier is preferably at least one of the monomers or oligomers having at least one unsaturated multiple bond illustrated by the vinyl group and the {meth}-acryl group. Specifically, it is at least selected one of monoallyl isocyanurate, diallyl isocyanurate, triallyl isocyanurate, triallyl cyanurate, ethylene glycol di-{meth}-acrylate, trimethyl propantri {meth}-acrylate, diallyl phthalate, divinyl benzene, vinyl toluene, vinyl pyridine, triallyl phthalate, vinyl trichlorosilane, vinyl tris (β-methoxy ethoxy) silane, vinyl triethoxy silane, vinyl trimethoxy silane, γ-({meth}-acryloxy propyl) trimethoxy silane, γ-({meth}-acryloxy propyl) triethoxy silane, γ-({meth}-acryloxy propyl) methyl dimethoxy silane and acryl silicone. In this specification, the term “{meth}” indicates that the particular portion may contain a methyl group.

These compounds can greatly change the properties of the polymer material in reaction with the polymer material, and thus can improve the resistance to the electrolyte and the heat resistance of the polymer material.

The polymer material is preferably at least one of the materials, or the modified materials thereof, including polybenzoimdazole, polyimide, polyether imide, polyamide imide, polyphenylene sulfide, polyether sulfone, polysulfone, polyether ether ketone, polymethyl pentene, aramide, polyvinylidene fluoride, polyamide, polyethylene telephthalate, polybutylene telephthalate, polyethylene naphthalate, polybutylene naphthalate, polyarylate, polyacetal and polyphenylene ether.

These polymer materials can be processed easily by the solvent cast method or the hot-melt method, and the modification reaction can be easily caused in the modification step. Also, these compounds have the advantage that the high melting point or the high glass transition temperature thereof can provide a separator with high heat resistance.

These modifiers are preferably compounds having a LUMO energy value of not less than 0.3 eV with the polymerization group thereof open.

In other words, a LUMO energy value of not less than 0.3 eV reduces the electron affinity for an increased electric potential for reduction, thereby making reduction difficult. Thus, the stability and durability of the separator are improved.

These modifiers include at least one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, vinyltris (β-methoxy ethoxy) silane, vinyl triethoxy silane, vinyltrimethoxy silane, γ-(acryloxy propyl) trimethoxy silane, γ-(methacryloxy propyl) trimethoxy silane, γ-(acryloxy propyl) triethoxy silane, and γ-(methacryloxy propyl) triethoxy silane.

Further, these modifiers are preferably compounds having a HOMO energy value of not more than −10.1 eV with the polymerization group thereof open.

In other words, a HOMO energy value not more than −10.1 V makes ionization difficult and the resulting higher electric potential for oxidization makes oxidization difficult, thereby improving the stability and durability of the separator.

Such modifiers include at least one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, heptadecafluoro decylacrylate, heptadecafluoro decylmethacrylate, vinyltris (β-methoxy ethoxy) silane, vinyl triethoxy silane, vinyltrimethoxy silane, γ-(acryloxy propyl) trimethoxy silane, and γ-(acryloxy propyl) triethoxy silane.

The —SiOSi— structure on the surface of the porous material can increase the density of the film on the modified surface of the polymer material. Further, the reduction resistance can be improved. A method for achieving this preferably includes the step of providing the predetermined substituent with the —SiOSi— structure or bonding a second modifier having the —SiOSi— structure to the predetermined substituent.

According to another aspect of the invention, there is provided a method of fabricating an electrode of a non-aqueous electrolyte secondary battery, comprising the steps of forming an electrode plate providing a positive electrode or a negative electrode for a non-aqueous electrolyte secondary battery, forming a porous film constituted of a polymer material and attaching the porous film on the electrode plate, wherein the porous film attaching step includes the substeps of bonding a predetermined substituent different from the group contained in the polymer material to the carbon atoms of the backbone chain of the polymer material through two or more successive carbon atoms in the predetermined substituent thereby to modify at least a part of the porous film.

The porous film forming step is preferably for forming a porous film on the surface of the electrode plate by coating a polymer material in liquid state on the surface of the electrode plate.

Also, the porous film forming step is preferably for forming a porous film for other than the electrode plate, and the porous film attaching step preferably includes the substep of securely fixing the porous film on the surface of the electrode plate after the porous film forming step.

In this way, any method of forming a porous film can be selected according to the object involved.

According to still another aspect of the invention, there is provided a porous film of a non-aqueous electrolyte secondary battery constituted of a polymer material, wherein at least a part of the polymer material has two or more successive carbon atoms bonded to the backbone chain of the polymer material and is modified by a predetermined substituent different from the group contained in the polymer material. In this specification, the wording “having two or more successive carbon atoms bonded to the carbon atoms of the backbone chain of the polymer material”, as explained above with reference to a fabrication method, indicates that the polymer of the polymer material and the predetermined substituent are bonded to each other not by ester linkage or by ether linkage but by carbon-carbon covalent linkage. In the case of the ester linkage with the —COOH group on the polymer backbone chain (—COOR), for example, two or more successive carbon atoms are not bonded to the polymer backbone chain (only one carbon atom).

Further, a protective layer induced from a modifier having a LUMO energy value of not less than 0.3 eV is preferably formed on the surface of the porous film with the polymerization group thereof open.

In other words, a LUMO energy value not less than 0.3 eV reduces the electron affinity for an increased electric potential for reduction, thereby making it difficult to reduce the protective layer. Thus, the stability and durability of the separator are improved.

This polymerization group preferably has an unsaturated multiple bond to facilitate the formation of the protective layer.

The modifiers having a LUMO energy value of not less than 0.3 eV with the polymerization group open include at least one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, vinyltris (β-methoxy ethoxy) silane, vinyl triethoxy silane, vinyltrimethoxy silane, γ-(acryloxy propyl) trimethoxy silane, γ-(methacryloxy propyl) trimethoxy silane, γ-(acryloxy propyl) triethoxy silane, and γ-(methacryloxy propyl) triethoxy silane.

Further, a protective layer induced from a modifier having a HOMO energy value of not more than −10.1 eV is preferably formed on the surface of the porous film with the polymerization group thereof open.

In other words, a HOMO energy value not more than −10.1 eV makes ionization difficult and increases the oxidization potential, so that the protective layer becomes difficult to oxidize. Thus, the stability and durability of the separator are improved.

This polymerization group preferably has an unsaturated multiple linkage to facilitate the formation of the protective layer.

The modifiers having a HOMO energy value of not more than −10.1 eV with the polymerization group open include at least one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, heptadecafluoro decylacrylate, heptadecafluoro decylmethacrylate, vinyltris (β-methoxy ethoxy) silane, vinyl triethoxy silane, vinyltrimethoxy silane, γ-(acryloxy propyl) trimethoxy silane, and γ-(acryloxy propyl) triethoxy silane.

Further, the predetermined substituent preferably has a structure of —SiOSi— or is bonded to a second modifier having the —SiOSi— structure. This is by reason of the fact that the —SiOSi— structure can form a dense layer on the surface of the porous film.

According to yet another aspect of the invention, there is provided an electrode of a non-aqueous electrolyte secondary battery, comprising an electrode plate providing a positive electrode or a negative electrode for a non-aqueous electrolyte secondary battery, and a porous film constituted of a polymer material formed integrally on the electrode plate with at least a part of the backbone chain of the polymer material modified by a predetermined substituent different from the group contained in the polymer material.

According to a further aspect of the invention, there is provided a non-aqueous electrolyte secondary battery, comprising a porous film fabricated by the method described above.

According to a still further aspect of the invention, there is provided a non-aqueous electrolyte secondary battery, comprising an electrode fabricated by the method described above.

The non-aqueous electrolyte secondary battery according to the present invention comprises a porous film fabricated by the aforementioned method of fabricating a porous film of a non-aqueous electrolyte secondary battery or an electrode fabricated by the aforementioned method of fabricating an electrode of a non-aqueous electrolyte secondary battery, and therefore is high in safety and low in cost.

### BRIEF DESCRIPTION OF THE DRAWINGS

FIG. 1 is a perspective sectional view schematically showing a battery according to an embodiment of the invention.

FIG. 2 is an enlarged sectional view showing an electrode plate portion in a secondary battery according to an embodiment of the invention.

FIG. 3 is a diagram showing the steps of forming a porous film on the electrode plate according to first and second embodiments of the invention.

FIG. 4 is a diagram showing the steps of forming a porous film on the electrode plate according to a third embodiment of the invention.

FIG. 5 is a diagram showing the steps of forming a porous film on the electrode plate according to a first reference.

FIG. 6 is a diagram showing the steps of forming a porous film on the electrode plate according to a second reference.

FIG. 7 is a diagram showing the steps of forming a porous film according to a fifth embodiment of the invention.

FIG. 8 is a diagram showing the steps of forming a porous film according to a sixth embodiment of the invention.

FIG. 9 is a diagram showing the steps of forming a porous film according to a seventh embodiment of the invention.

FIG. 10 is a diagram showing the steps of forming a porous film according to an eighth embodiment of the invention.

### DESCRIPTION OF THE PREFERRED EMBODIMENTS

Now, a method of fabricating a porous film of a non-aqueous electrolyte secondary battery, a porous film of a non-aqueous electrolyte secondary battery, a method of fabricating an electrode of a non-aqueous electrolyte secondary battery, an electrode of a non-aqueous electrolyte secondary battery, and a non-aqueous electrolyte secondary battery according to the present invention will be explained in detail with reference to embodiments thereof. The present invention is not confined to the embodiments described below. In these embodiments of the invention, a lithium secondary battery is taken as an example. Nevertheless, the invention is not limited to the lithium secondary battery but applicable with equal effect to any non-aqueous electrolyte secondary battery, comprising an electrode unit having a stack of a positive electrode and a negative electrode, a non-aqueous electrolyte and a case containing the electrode unit and the non-aqueous electrolyte therein. Also, the method of fabricating an electrode of a non-aqueous electrolyte secondary battery according to the invention is applicable to an electric double-layer capacitor or the like having an electrode configured of an electrode composite member containing active carbon as an activation material and formed in layers on the surface of a collector. In the present specification, therefore, the term “battery” is assumed to include “capacitor”.

[Electrode of lithium secondary battery and fabrication method] A method of fabricating an electrode of a lithium secondary battery and the particular electrode of a lithium secondary battery will be explained below.

A method of fabricating an electrode of a lithium secondary battery according to this embodiment comprises the steps of forming an electrode plate and attaching a porous film.

(Electrode plate forming step)

The electrode plate forming step is for forming an electrode plate providing a positive electrode or a negative electrode of a lithium secondary battery.

This step can be carried out by a well-known method of fabricating a positive electrode or a negative electrode of a well-known lithium secondary battery, to which method the present invention is not confined. In applying the present invention to a non-aqueous electrolyte secondary battery other than the lithium secondary battery, a well-known method of fabricating the positive electrode or the negative electrode of a corresponding non-aqueous electrolyte secondary battery is applicable.

Specifically, the positive electrode is constituted of a sheet member having a lithium-metal composite oxide as a positive electrode active material capable of intercalating and releasing lithium ions at the time of charging and occluding lithium ions at the time of discharging. The lithium-metal composite oxide has a superior performance as an active material having a high diffusion performance of electrons and lithium ions. By using a composite oxide of lithium and a transition metal, therefore, a high charge-discharge efficiency and a satisfactory cycle characteristic can be obtained. Further, the positive electrode is preferably coated on the collector as a positive electrode composite member containing a mixture of a positive electrode active material, a conduction agent and a binder.

The positive electrode active material is not specifically limited and may be any well-known active material of lithium-metal composite oxide. An example is Li₍₁₋ₓ₎NiO₂, Li_{(1-X)MnO}₂, Li₍₁₋ₓ₎Mn₂O₄, Li_{(1-X)}CoO₂ or a material made by adding a transfer metal such as Li, Al or Cr to Li_{(1-X)}NiO₂, Li_{(1-X)}MnO₂, Li_{(1-X)}Mn₂O₄ or Li_{(1-X)}CoO₂. The positive electrode active material is not limited to a single substance but may be a mixture of a plurality of substances. In the illustration of the positive electrode active material, X designates a number of 0 to 1.

The negative electrode, on the other hand, is a sheet member capable of occluding lithium ions at the time of charging and releasing lithium ions at the time of discharging. Especially, it is preferable to use a negative electrode composite member as a mixture of a negative electrode active material, a conduction agent and a binder coated on a collector. The negative electrode active material is not limited specifically by the type of the active material, but can be a well-known one. In particular, a carbon material such as natural graphite or artificial graphite having a high crystallinity has a superior performance of diffusion and absorption of lithium ions. By using one of these carbon materials as a negative electrode active material, therefore, a high charge-discharge efficiency and a superior cycle characteristic are obtained. Further, from the viewpoint of the battery capacity, it is preferable to use lithium metal or a lithium alloy as a negative electrode.

An example of the above-mentioned method for forming a positive electrode or a negative electrode will be explained below. For forming a positive electrode, LiNiO₂ constituting a positive electrode active material, acetylene black constituting a conduction agent and polyvinylidene fluoride constituting a binder are mixed with each other to make a positive electrode composite material. This positive electrode composite material is dispersed in N-methyl-2-pyrrolidone, constituting a dispersant, to form a slurry. This slurry is coated on a positive electrode collector of aluminum, dried and pressed to form a positive electrode composite material layer making up a positive electrode. For forming the negative electrode, on the other hand, graphite, constituting a negative electrode activation material, is mixed with polyvinylidene fluoride, constituting a binder, to make a negative electrode composite material. This negative electrode composite material is dispersed in N-methyl-2-pyrrolidone, constituting a dispersant, to form a slurry. This slurry is coated on a negative electrode collector of copper, dried and pressed to form a negative electrode composite material layer making up a negative electrode.

(Porous film attaching step)

The porous film attaching step is for attaching a modified porous film on the surface of an electrode plate. The porous film attaching step includes the porous film forming step, the modification step and, if required, the fixing step. The modification step and the fixing step can be carried in any order at any time after the porous film forming step.

(Porous film forming step)

The porous film forming step is for forming a porous film configured of a polymer material. In the porous film forming step, either a porous film can be fixed on the surface of the electrode plate at the same time that the porous film is formed, or a porous film can be formed separately from the electrode plate. In the case where the porous film is formed independently of the electrode plate, a fixing step, described later, is required.

The polymer material used in this case may be a single polymer, a mixture of two or more polymers or a copolymer. Also, the polymer material, if crystalline, preferably has a melting point of not lower than 150° C., and a polymer material, if amorphous, preferably has a glass transition temperature of not lower than 150° C. The porous film composed of a heat-resistant polymer having a melting point or a glass transition temperature of not lower than 150° C. is not shrunk or melted at high temperatures exceeding 150° C. Even in the case where the internal temperature of the cell exceeds 150° C., therefore, the cell safety can be secured by the porous film.

The polymer material is preferably at least one of the materials, or the modified materials thereof, including polybenzoimdazole, polyimide, polyether imide, polyamide imide, polyphenylene sulfide, polyether sulfone, polysulfone, polyether ether ketone, polymethyl pentene, aramid, polyvinylidene fluoride, polyamide, polyethylene telephthalate, polybutylene telephthalate, polyethylene naphthalate, polybutylene naphthalate, polyarylate, polyacetal and polyphenylene ether. These polymers have an especially high melting point or glass transition temperature among heat-resistant polymers having a melting temperature or a glass transition temperature, as the case may be, of not lower than 150° C. Thus, a porous film having a very high heat resistance is obtained. Also, it is especially preferable to use at least one of polyethylene telephthalate, polybutylene telephthalate or the like saturated polyester, polyamide, polyamide imide, polyethylene naphthalate, polybutylene naphthalate, polyvinylidene fluoride or a modified polymer thereof, in view of the fact that the hydrogen in the molecules is liable to be abstracted to generate a radical. Further, saturated polyester or, in particular, polybutylene telephthalate which can be bonded with a modifier, to abstract hydrogen to a greater extent, is preferable.

The polymer material can be mixed with a modifier before forming a porous film. The amount of modifier to be added will be explained later with reference to the modification step. The modifier is defined as the portion of two or more successive carbon atoms (the portion derived from the unsaturated multiple bond such as double linkage) capable of being bonded with the carbon atoms of the backbone chain of the polymer of the polymer material, and a substance adapted to be bonded by substitution or addition reaction, which substance improves the resistance to electrolyte after modification. Specifically, the solubility in the electrolyte is reduced by the increased molecular weight or the change in the solubility parameter of the polymer material after modification reaction. The modifier is preferably not reactive with the polymer material in the porous film forming step. If the reaction occurs in the porous film forming step, the gelation or solidification reaction of the polymer material develops and makes it impossible to form a porous film.

The modifier is specifically a molecule having at least one reaction group such as an unsaturated multiple bond to be substituted into or added to the carbon atoms of the backbone chain portion of the polymer, and preferably includes, as a first category, at least one of monoallyl isocyanurate, diallyl isocyanurate, triallyl isocyanurate, triallyl cyanurate, ethylene glycol di-{meth}-acrylate, trimethyl propantri {meth}-acrylate, diallyl phthalate, divinyl benzene, vinyl toluene, vinyl pyridine, triallyl phthalate, vinyl trichlorosilane, vinyl tris (β-methoxy ethoxy) silane, vinyl triethoxy silane, vinyl trimethoxy silane, γ-({meth}-acryloxy propyl) trimethoxy silane, γ-({meth}-acryloxy propyl) triethoxy silane, γ-({meth}-acryloxy propyl) methyl dimethoxy silane and acryl silicone. A second category of the modifier is a molecule having two or more reaction groups for bonding the polymer chains and includes diallyl isocyanurate, triallyl isocyanurate, triallyl cyanurate, ethylene glycol di-{meth}-acrylate, trimethyl propantri {meth}-acrylate, diallyl phthalate, divinyl benzene, vinyl toluene, vinyl pyridine, triallyl phthalate. A third category of the modifier includes vinyl trichlorosilane, vinyl tris (β-methoxy ethoxy) silane, vinyl triethoxy silane, vinyl trimethoxy silane, γ-({meth}-acryloxy propyl) trimethoxy silane, γ-({meth}-acryloxy propyl) triethoxy silane and γ-({meth}-acryloxy propyl) methyl dimethoxy silane.

The molecules (first category) having one or more reaction groups such as an unsaturated multiple bond substituting the side chain or the terminal portion of the polymer substitute the group (hydrogen, etc.) bonded to the carbon atoms of the backbone chain of the polymer, thereby probably increasing the molecular weight or changing the solubility parameter as compared with the polymer before modification for an improved resistance to electrolytes. The molecules (second and third categories) having two or more reaction groups for bonding the chains of the polymer, on the other hand, are probably three-dimensionally crosslinked to improve the resistance to electrolytes as compared with the polymer before modification. The difference between the second and third categories lies in that the second category has two or more unsaturated multiple bonds, while the third category has at least one unsaturated multiple bond and at least one reactive functional group. More preferable examples of these compounds include monoallyl isocyanurate, vinylpyridine and vinyl toluene in the first category, triallyl isocyanurate, triallyl cyanurate, trimeta allyl isocyanurate and diallyl isocyanurate in the second group, and vinyl trimethoxy silane, γ-(acryloxy propyl) trimethoxy silane, γ-(methacryloxy propyl) trimethoxy silane or the like silane coupling agents in the third group. In all of the first to third categories of modifiers, it is preferable for the modifiers to have the chemical structure —SiOSi— to achieve a higher density of the surface of the porous film formed.

The polymer materials may contain a salt. The salt is dispersed in the polymer film, and therefore the porous film can be easily formed by extracting the salt from the polymer film subsequently. The salt, though not specifically limited, preferably includes a lithium salt. For example, a preferable salt is at least one of lithium chloride, lithium nitrate, lithium iodide, borotetrafluoro lithium, lithium bis-trifluothomethyl sulfonylimide and lithium hexafluoro iodide. These lithium salts have a superior solubility in solvents and therefore can control the pore diameter according to the added amount thereof.

The method employed to form a porous film, though not specifically limited, may be a solvent cast method or a hot-melt method. The thickness of the porous film is preferably as small as possible from the viewpoint of energy density. It is preferably about 5 μm to 50 μm.

In the solvent cast method, the polymer material is dissolved in a good solvent to assume a liquid phase, and after being coated on a flat plate, is deposited on the flat plate. In this case, the use of an electrode plate as the flat plate makes it possible to securely fix the porous film and the electrode plate to each other while at the same time forming the porous film. Specifically, there are available several methods including (1) a method in which the polymer material is dissolved in a good solvent and, after being coated on a flat plate, the flat plate is brought into contact with a poor solvent of the polymer material, (2) a method in which a polymer material is dissolved in a solvent mixed with a poor solvent having a higher boiling point than a good solvent, and after the solution is coated on a flat plate, the good solvent is evaporated, and (3) a method in which a polymer material is dissolved in a poor solvent having no affinity with a good solvent and having a higher boiling point than a good solvent, or dissolved in a good solvent with salt dissolved or mixed therewith, and after being coated on a flat plate, the good solvent is evaporated and then the salt or the poor solvent, as the case may be, is extracted.

The good solvent preferably includes but is not specifically limited to N-methyl-2-pyrrolidone, dimethyl sulfoxide, dimethyl formamide, dimethyl acetoamide, methyl ethyl ketone, acetone, xylene, toluene, decalin or paraffin. A solvent suitable for the polymer is thus selected, and the polymer material, if difficult to dissolve, is melted by being heated. Also, in order to adjust the viscosity, a viscosity improver such as methyl cellulose, carboxymethyl cellulose, polyethylene oxide, polyvinyl alcohol, etc. can be added. Further, for forming a uniform film, a surface active agent, antifoaming agent, surface regulator, etc. may be added. A poor solvent includes water, alcohol, ketone, etc.

A method of coating a polymer solution on a flat plate such as an electrode plate may be selected from the methods using a blade coater, a roll coater, a knife coater and a die coater in accordance with the shape of the flat plate such as the electrode unit. The polymer solution, if coated directly on the electrode plate, preferably has a high viscosity and is not substituted by the air in the pores of the electrode plate. Other methods of coating a polymer solution on a flat plate like the electrode plate include a method in which a flat plate such as the electrode plate is dipped in a polymer solution. In this coating method, a polymer solution having a low viscosity is preferably used to secure smooth separation of the solution from the flat plate recovered from the polymer solution. Among these methods, a method in which a polymer solution is coated on a flat plate like a smooth film composed of PET or PPS and the porous film thus formed is securely fixed on the electrode plate by transfer or the like means in order to avoid the effect of the shape or pores of the electrode.

In the hot-melt method, the polymer material melted into a liquid phase is solidified by being cooled after being coated on a base member such as an electrode plate or a film. Specifically, a polymer such as polyamide or polyester having a comparatively small molecular weight is melted and mixed with a plasticizer having a high boiling point, and the polymer melted by a heated die or the like is solidified by being cast and cooled on a flat plate like the electrode plate, after which the plasticizer is extracted using an organic solvent thereby to produce a porous film. Also in this case, the flat plate may, of course, be other than the electrode plate.

The melt-blow method is still another alternative, in which a melted polymer material is extruded out of pores of a spinneret to make an unwoven fabric composed of fine fibers having a diameter of not more than 10 μm.

The thickness and porosity of the porous film can be adjusted by pressure rolls or the like.

(Fixing step)

In the fixing step, the porous film formed in the porous film forming step is securely fixed integrally on the surface of the electrode plate. As long as the porous film and the electrode plate can be securely fixed to each other, the fixing step is not specifically limited to any means. Specific means include thermal fusion and welding. The porous film and the electrode plate are not required to be securely fixed to each other over the entire surfaces thereof, but may be partially fixed to each other to such an extent as not to come off during the cell fabrication process. The fixing step can be carried out after the modification step described below.

(Modification step)

In the modification step, at least a portion of the backbone chain of the polymer material making up the porous film formed on the surface of the electrode plate is modified with a predetermined substituent different from the group contained in the particular polymer material. The predetermined substituent is used to modify the polymer material in order to increase the molecular weight of the polymer material or greatly change the solubility parameter for the electrolyte thereby to improve the resistance of the modified polymer material to the electrolytes. The predetermined substituent include those that cause the reaction of the modifiers with the polymer.

The modifier described above, if not mixed with the polymer material in the porous film forming step, is coated on the surface of the porous film in the modification step. The coating method is not specifically limited.

The amount of the modifier mixed with the polymer material in the porous film forming step or the amount of the modifier coated on the surface of the porous film in the modification step is not specifically limited as long as the effect of coating is exhibited.

In the modification step, preferably, one to 50% of the side chain or the terminal of the polymer contained in the polymer material is finally modified with the predetermined substituent. This value depends on the composition of the polymer material and the type of the modifier. An amount smaller than the figure described above, however, would generally reduce the property difference in the polymer material before and after the modification. A greater amount, on the other hand, would not change the property easily. The function and productivity as a separator, therefore, is sufficiently high in the range described above.

The backbone chain of the polymer material can be modified, for example, either by (1) radiating a high-energy beam or by (2) heating after coating the initiator on the surface of the porous film.

The former method (1) has the advantage that no assistant is required to promote the reaction and the reaction, even with an inert substance, is made possible under normal reaction conditions, with the result that the margin of selection of the modifier is widened. The high-energy beam includes, for example, an electron beam, (near, far and vacuum) ultraviolet light, X rays, gamma rays, low-temperature plasma radiation and any combination thereof. The atmosphere for these high-energy beam radiation is not specifically limited. The radiation may be carried out, for example, in the air, a nitrogen atmosphere or an argon atmosphere. Preferably, the radiation should be carried out in an inert gas (rare gas, nitrogen, etc.) atmosphere. Also, the dosage, intensity or energy of the high-energy beam is not limited specifically and is appropriately changed to assure the required progress of modification of the porous film involved.

The latter method (2) can be implemented with simple equipment. A peroxide, an azide or a similar radical generator can be used as a initiator. The peroxide includes an organic peroxide with hydroperoxide, dialkyl peroxide or peroxy ketal contained in the molecule thereof, and the azide includes azobis isobutylonitrile, etc. The bond starting agent is dissolved in a solvent such as alcohol or ketone and coated on the porous film. The preferable concentration of the bond starting agent is one part by mass of the initiator to 4 to 999 parts by mass of the solvent added and molten (0.1 to 20 mass % solution). The method of heating the electrode formed with the porous film is not specifically limited, is preferably implemented in an inert gas atmosphere. The heating temperature and time are determined by the decomposition constant of the bond starting agent, the amount to be added and the type of the polymer material.

(Other steps)

The fabrication method according to the invention may further comprise the protection step. The protection step is for forming a protective layer, induced from the modifier, on the surface of the porous film. The protection step can be carried out any time after the porous film forming step.

For forming the protective layer on the surface of the porous film, substantially the same method as the method employed in the modification step for modifying the porous film with the modifier can be used. Examples include (1) a method including the heat treatment step and a method (2) using a high-energy beam.

In the method (2) employing heat treatment, a modifier and a bond starting agent (such as an organic peroxide or an azo compound providing a radical generator) are mixed with each other and dissolved in a solvent, and after coating the resulting solution on the porous film, heated in an inert atmosphere. In this way, the modifier is polymerized or reacts with the porous film thereby to form the protective layer.

In the method (2) using a high-energy beam, the modifier and the bond starting agent are mixed as required and dissolved in a solvent. The resulting solution is coated on the porous film, after which a high-energy beam such as an electron beam (near, far or vacuum), ultraviolet light, x rays, gamma rays or low-temperature plasma rays or any combination thereof are radiated, so that the modifier is polymerized or reacts with the porous film thereby to form the protective layer.

In both the methods (1) and (2), the surface of the porous film can be coated with the solution using a brush, a coater or the like, or by dipping the porous film in the solution.

A compound having a polymerization group may be used as a modifier. In this specification, the term “the polymerization group” is defined as a functional group such as the unsaturated multiple bond (preferably having two or more functional groups) reactive with itself or a polymer compound forming a porous film. Preferably, it is a compound having an unsaturated multiple bond in the molecules thereof.

This modifier is a compound having a LUMO energy value of not less than 0.3 eV or preferably not less than 0.5 eV with the polymerization group open, or a compound having a HOMO energy value of not more than −10.1 eV or more preferably not more than −10.4 eV with the polymerization group open. The wording “with the polymerization group open” means a chemical structure after the reaction between the polymerization group of a modifier of one molecule and a polymer material forming the porous film, to which structure hydrogen atoms are added excepting the portions derived from the polymer material of the porous film.

The HOMO and LUMO energy values are calculated by the PM method of MOPAC97. The results of various tests conducted, though not described in detail, show that a compound exhibiting a sufficient reduction resistance is SBR (LUMO 0.3 eV) and a compound exhibiting a sufficient oxidization resistance is NBR (10.3 eV).

The compound having a HOMO energy value not more than −10.1 eV with the polymerization group open includes at least selected one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, heptadecafluorodecyl acrylate, vinyltris (P-methoxy ethoxy) silane, γ-(acryloxy propyl) trimethoxy silane and γ-(acryloxy propyl) triethoxy silane. At least one of these compounds is preferably used as a modifier.

Further, a dense layer can be formed by causing the second modifier having the structure —SiOSi— to react with the surface of the porous film modified by the modifier. Using a modifier having an OH group (including the protected one such as methoxy), for example, it is possible to cause the reaction of the second modifier constituted of such compounds as siloxane and polysiloxane with an arbitrary silicon bonded with the OH group or OR group (R indicates the alkyl group, phenyl group, etc.) on the one hand and organosiloxane and organopolysiloxane produced when an arbitrary a hydrogen of siloxane and polysiloxane is substituted by an alkyl group, a phenyl group, etc. on the other hand.

A dense layer having the —SiOSi— structure is formed on the surface of the porous film by the reaction between the OH group induced from the OH group or the OR group, etc. contained in the second modifier and the OH group, the COOH group, etc. contained in the first modifier. The second modifier preferably has a small molecular weight. An excessively small molecular weight, however, would lower the boiling point of the second modifier or otherwise cause an unsuitable property. Therefore, the molecular weight is set to the proper level to secure satisfactory properties including the boiling point. The boiling point, for example, is preferably not lower than 80° C.

An explanation will be given of specific examples of the method of introducing the —SiOSi— structure into the porous film by the second modifier.

Methods in which the second modifier is mixed with the first modifier and coated.

(1) A modifier having an unsaturated multiple bond in a solvent and a hydrolyzed compound (second modifier) having the —SiOSi— structure are coated at the same time on a porous film, and after being deposited by impregnation or the like, the polymer surface is modified by a compound (modifier or the like) having an unsaturated multiple bond using a high-energy beam, after which the second modifier and the first modifier are condensed and set by dehydration at a high temperature.

(2) A modifier having an unsaturated multiple bond in a solvent, a initiator for bonding the modifier with the polymer material of the porous film and a second modifier having the hydrolyzed —SiOSi— structure are coated and attached by impregnation or the like at the same time on the porous film, after which the polymer surface is modified by the first modifier by heating while at the same time condensing by dehydration and setting the second modifier and the first modifier.

Methods in which the second modifier is coated after modifying the polymer surface with the first modifier.

(1) After modifying the polymer surface by a modifier or the like, a second modifier having the —SiOSi— structure hydrolyzed in a solvent is coated and attached by impregnation or the like and condensed by dehydration and set at a high temperature.

(2) After modifying the polymer surface by a modifier or the like, a solvent, a setting catalyst and a second modifier are coated on the porous film and deposited by impregnation or the like, after which it is set at a high temperature.

According to these methods, as shown by chemical formulae 1 to 3, the reaction proceeds (the silane coupling agent and the siloxane may react either according to the formulae or earlier than the formulae indicate), thereby producing a porous film having a 20 structure as expressed by chemical formula 3.

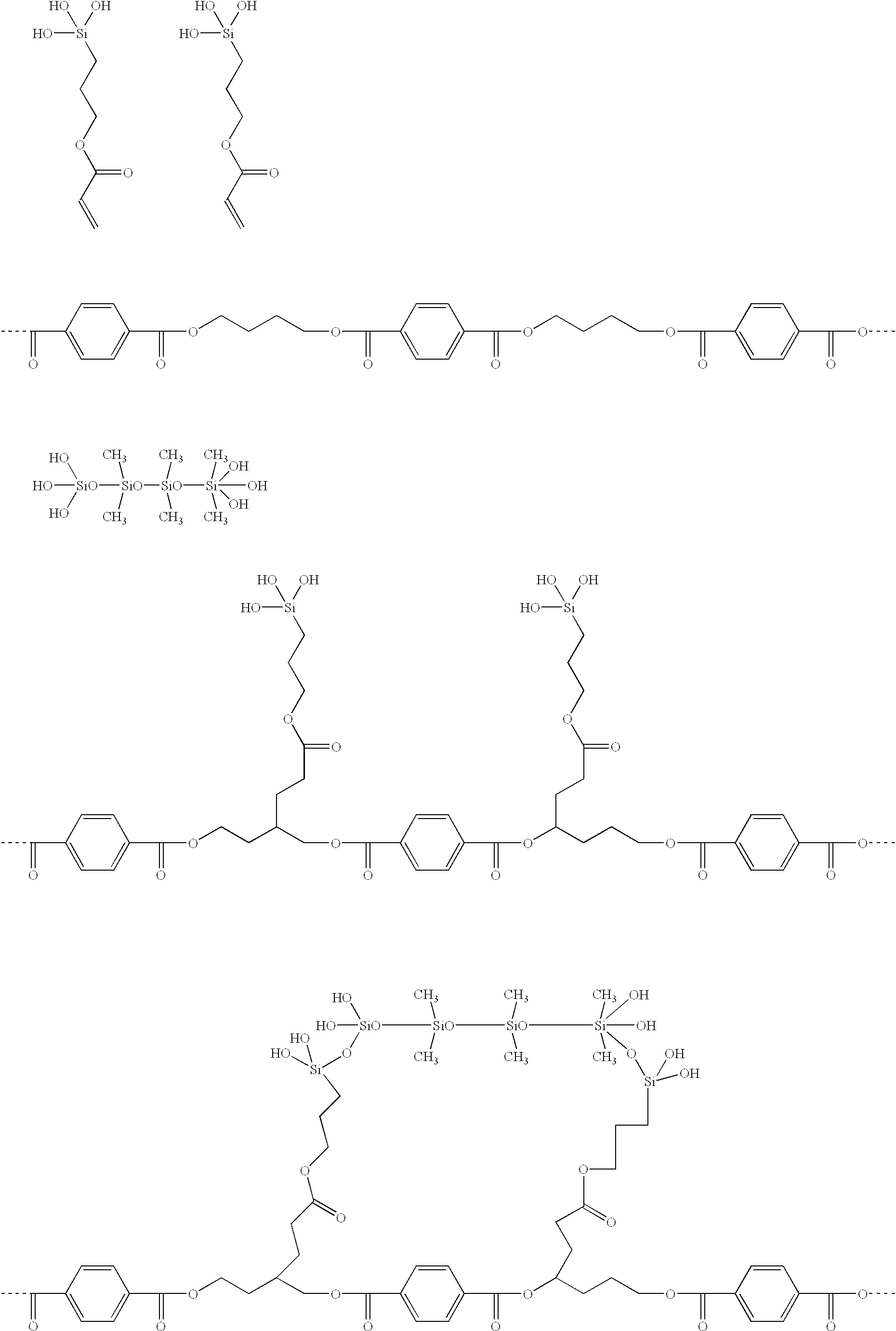

Note

The —SiOSi— structure may be introduced into the porous film by a method using a compound having the —SiOSi— structure as a modifier as indicated by chemical formula 4. In this case too, as in the aforementioned method, a porous film having the structure as indicated by chemical formula 3 is obtained.

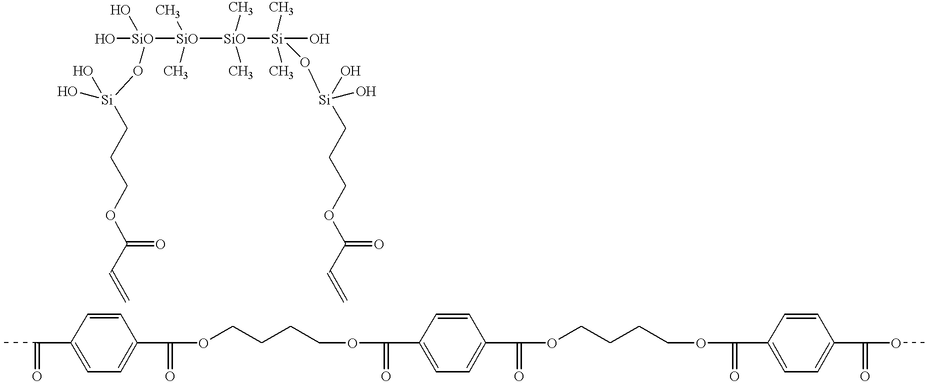

[Porous film of lithium secondary cell and fabrication method]

Now, an explanation will be given of a method of fabricating a porous film of a lithium secondary cell and also the porous film itself of the lithium secondary cell.

The method of fabricating the porous film of the lithium secondary cell according to this embodiment comprises the porous film forming step and the modification step.

The porous film forming step and the modification step in the method of fabricating the porous film according to this embodiment are similar to the corresponding steps described above with reference to the method of fabricating the electrode of the lithium secondary cell, and therefore will not be described below.

[Lithium secondary cell]

The lithium secondary cell according to this embodiment comprises an electrode unit having the positive electrode and the negative electrode stacked one on the other. The electrode fabricated by the aforementioned fabrication method is used for the positive and negative electrodes of this lithium secondary cell.

Therefore, the component elements other than the electrodes are not specifically limited and can be constituted in a well-known way.

[Non-aqueous electrolyte secondary battery]

(Electrode plate forming step)

The electrodes of the cell used in the embodiments and the references were fabricated by the method described below.

A negative electrode 2 is composed of a negative electrode composite material layer 22 including 95 parts by mass of artificial graphite, 3 parts by mass of SBR, one part by mass of carboxyl methyl cellulose and one part by mass of the silane coupling agent, which composite material layer 22 is formed on a negative electrode collector 21 (Cu foil).

A positive electrode 1 is composed of a positive electrode composite material layer 12 including 85 parts by mass of lithium nickelate, 10 parts by mass of carbon black, 4 parts by mass of polytetrafluoroethylene and one part by mass of carboxymethyl cellulose, which composite material layer 12 is formed on a positive electrode collector 11 (Al foil).

[Porous film forming step, fixing step, modification step and other steps]

These steps will be explained with reference to each embodiment and each reference.

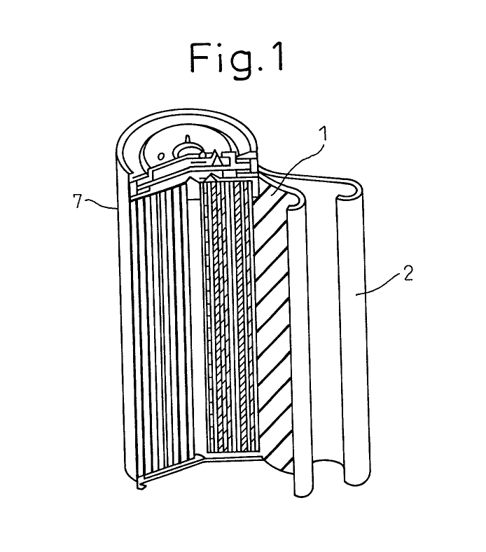

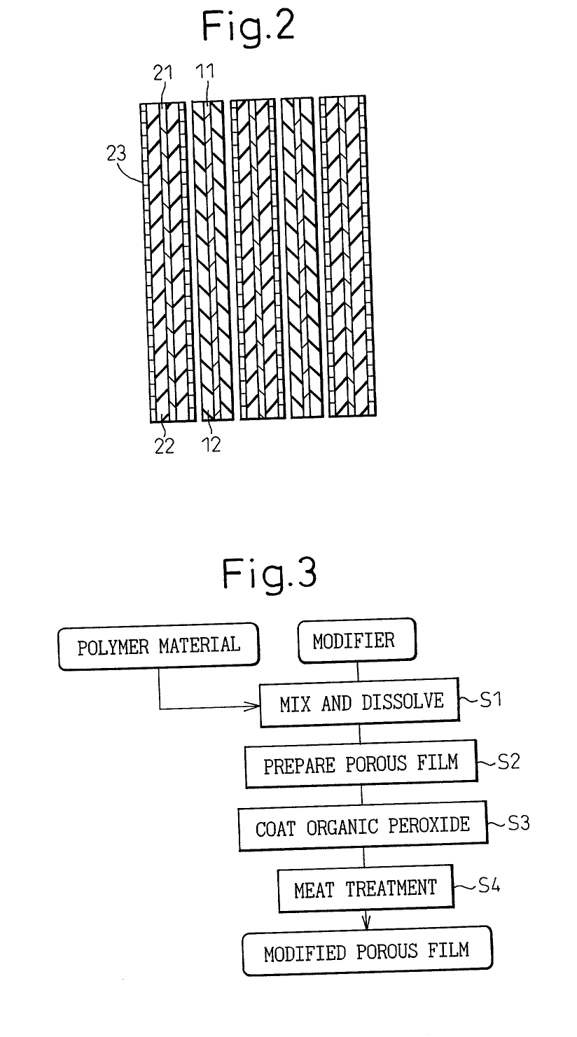

A method of fabricating a battery as a final process is described. Specifically, the lithium secondary battery according to these embodiments and references, as the structure thereof is schematically shown in FIG. 1, is of the wound electrode unit type, and comprises a positive electrode 1 capable of intercalating and releasing lithium ions, a negative electrode 2 composed of a carbon material capable of releasing and occluding the lithium ions released from the positive electrode 1, and an electrolyte. The negative electrode 2 has the two sides thereof each formed with a porous film 23. The positive electrode 1, the negative electrode 2 and the electrolyte are hermetically sealed in a case 7. In the case 7, the positive electrode 1 and the negative electrode 2, as shown in FIG. 2, are insulated from each other by the porous films formed on the surfaces of the negative electrode 2. The electrolyte is composed of a solvent including 3 parts by volume of ethylene carbonate and 7 parts by volume of diethyl carbonate 7, in which LiPF₆ in the amount of 1 mol per liter of the solvent is dissolved in the solvent.

(Embodiment 1)

The electrodes were fabricated according to the process drawing shown in FIG. 3.

A polymer material composed of 30 parts by mass of saturated polyester (Vylon KS001 made by TOYOBO CO., Ltd.) and six parts by mass of γ-methacryloxy propyl trimethoxy silane constituting a modifier (KBM503 made by Shin-Etsu Chemical Co., Ltd.) are dissolved at 125° C. in 70 parts by mass of N-methyl pyrrolidone as a solvent thereby to produce a polymer solution (S1).

This solution is coated on the negative electrode with blade coater, dipped in water for five minutes and dried thereby to produce porous films on the negative electrode (S2).

This electrode was dipped for ten seconds in a solution obtained by dissolving one part by mass of dicmyl peroxide (Percmyl D made by NOF CORPORATION) in 99 parts by mass of ethanol, and dried thereby to remove the ethanol (S3).

The electrodes were hermetically sealed in an Ar atmosphere and subjected to heat treatment for two hours at 150° C. (S4).

The process described above is considered to have caused the reaction shown in the following schematic diagram.

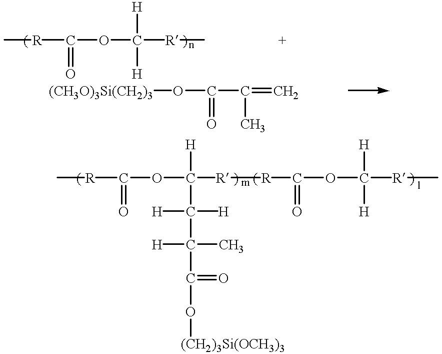

A battery comprising the negative electrode and the positive electrode described above alone but using no separator was fabricated and held for one hour at 90° C.

(Embodiment 2)

An electrode was prepared in accordance with the process drawing of FIG. 3.

Thirty parts by mass of saturated polyester (Vylon KS001 made by TOYOBO CO., Ltd.) constituting a polymer material and 6 parts by mass of triallyl isocyanurate (TAIC made by Nippon Kasei Chemical Co., Ltd.) as a modifier are dissolved in 70 parts by mass of N-methyl pyrrolidone as a solvent at 125° C. to produce a polymer solution (S1).

This solution was coated on the negative electrode with blade coater, and after being dipped in water for five minutes, dried thereby to produce porous films on the negative electrode (S2).

This electrode was dipped for ten seconds in a solution obtained by dissolving one part by mass of dicmyl peroxide (Percmyl D made by NOF CORPORATION) in 99 parts by mass of ethanol, and dried to remove the ethanol (S3).

This electrode was hermetically sealed in Ar atmosphere and heat treated for 2 hours at 150° C. (S4).

This process is considered to have developed the reaction shown in the following schematic drawing.

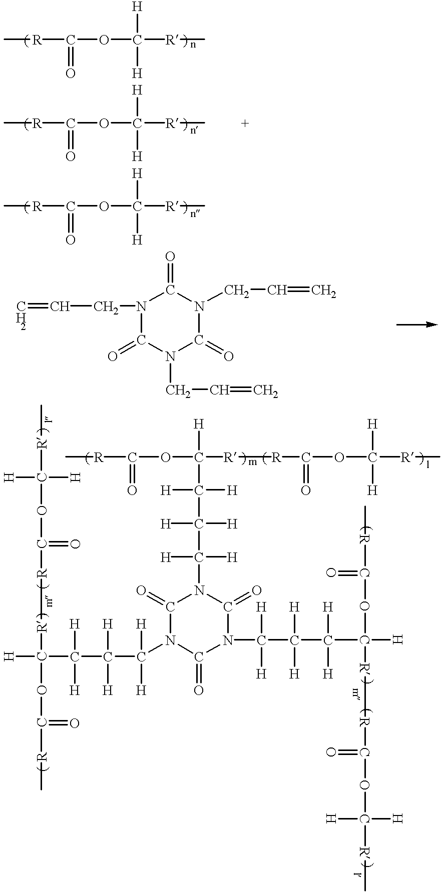

A battery comprising only a combination of these negative and positive electrodes only without using any separator was prepared and held for one hour at 100° C.

(Embodiment 3)

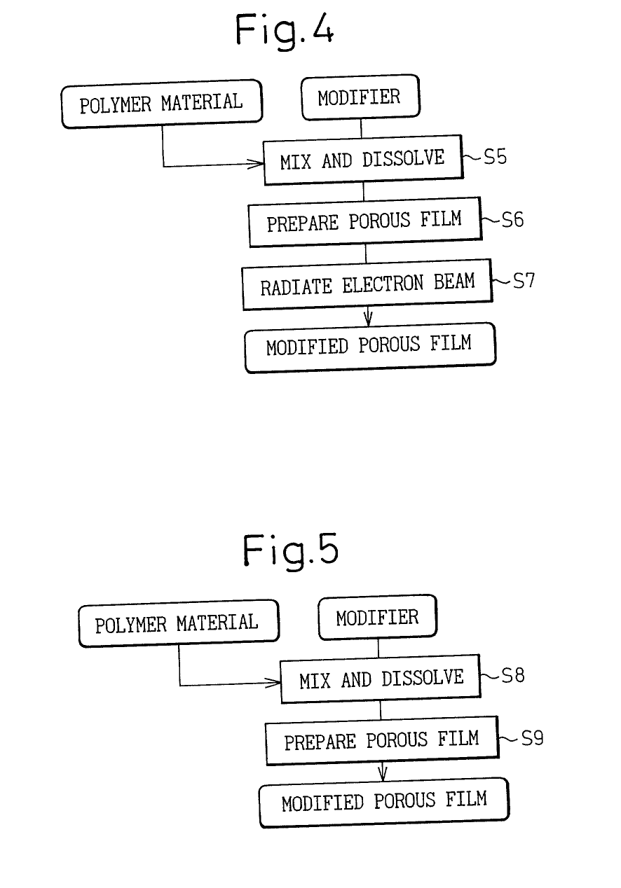

An electrode was fabricated in accordance with the process drawing of FIG. 4.

Thirty parts by mass of saturated polyester (Vylon KS001 made by TOYOBO CO., Ltd.) as a polymer material and 6 parts by mass of triallyl isocyanurate (TAIC made by Nippon Kasei Chemical Co., Ltd.) were dissolved in 70 parts by mass of N-methyl pyrrolidone at 125° C. to produce a polymer solution (S5).

This solution was coated on the negative electrode with blade coater, and after being dipped in water for five minutes, dried thereby to produce porous films on the negative electrode (S6).

This electrode was irradiated with an electron beam with a total absorption dosage of 500 kGy in N₂ atmosphere (S7).

This process is considered to have developed the reaction of formula 2 in the schematic diagram.

A battery comprising only a combination of these negative and positive electrodes but no separator was prepared and held for one hour at 100° C.

(Reference 1)

An electrode was fabricated based on the process drawing of FIG. 5.

Thirty parts by mass of saturated polyester (Vylon KS001 made by TOYOBO CO., Ltd.) was dissolved in 70 parts by mass of N-methyl pyrrolidone at 125 OC to produce a polymer solution (S8).

This solution was coated on the negative electrode with blade coater, and then dipped in water for five minutes and dried thereby to produce porous films on the negative electrode (S9).

In the process described above the reaction shown in the following schematic diagram is considered to have proceeded.

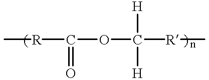

A battery comprising only a combination of the negative electrode and the positive electrode without any separator was fabricated and held for one hour at 100° C.

(Reference 2)

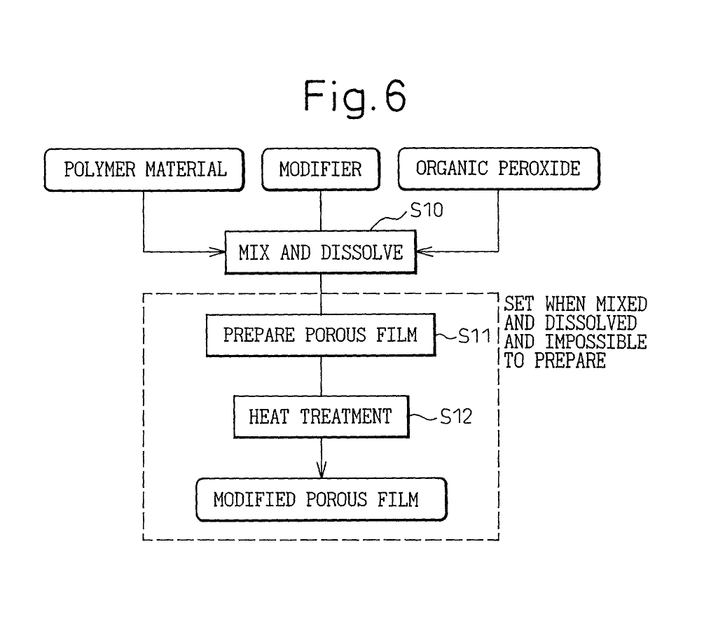

An electrode was prepared based on the process drawing of FIG. 6.

Thirty parts by mass of saturated polyester (Vylon KS001 made by TOYOBO CO., Ltd.), 6 parts by mass of triallyl isocyanurate (TAIC made by Nippon Kasei Chemical Co., Ltd.) and 0.9 parts by mass of dicmyl peroxide (Percmyl D made by NOF CORPORATION) were dissolved in 70 parts by mass of N-methyl pyrrolidone at 125° C. (S10). In the process, the viscosity began to increase after about three hours, and the resulting inferior coatability made it impossible to produce a uniform porous film. Further, the polymer solution was gelatinized in another 5 hours, and therefore the subsequent process was suspended (S11, S12).

Specifically, the reaction similar to Formula 2 above is considered to have progressed to step S10 thereby to form a polymer gel.

[Measurement of discharge capacity]

The discharge capacity of the battery according to each embodiment and reference was measured at room temperature according to the normal method.

The results are shown in Table 1.

TABLE 1

| | Discharge capacity per unit of positive |
|---|---|
| | electrode active material |
| Embodiment 1 | 144 mAh |
| Embodiment 2 | 146 mAh |
| Embodiment 3 | 145 mAh |
| Reference 1 | Shorted and measurement impossible |
| Reference 2 | No porous film formed due to gelation |

As is obvious from this table, a practical battery could not be obtained according to the references

[Measurement of gelation ratio of porous film]

In order to evaluate the resistance of the porous film to electrolytes, a porous film was newly formed on a Cu foil by the method of each embodiment and reference 1, and the particular porous film alone was separated from the Cu foil and used as a test piece.

The mass of this porous film was determined as WO.

Each porous film was dipped in a solvent composed of 3 parts by volume of ethylene carbonate and 7 parts by volume of diethyl carbonate and after being hermetically sealed at 120° C., left to stand for one hour.

The porous film was subsequently cooled slowly to normal temperature and washed three times with ethanol thereby to remove the resin dissolved in the electrolyte. The mass after the porous film was recovered and dried was determined as W.

Gelation ratio=W/W₀

As a result, the gelation ratio was 0.91 for the first embodiment, 0.97 for the second embodiment, 0.95 for the third embodiment, and 0.81 for the first reference. Also, after measuring the gelation ratio, the appearance of each test piece was observed by naked eye. As a result, it was found that the test pieces of the first, second and third embodiments maintained the state of a porous film, whereas the test piece for the first reference has lost the state of the porous film.

Thus, it has become apparent that a porous film having a high resistance to electrolytes could be obtained in the embodiments, whereas the resistance of the porous film to electrolytes in the references is low.

(Embodiment 4)

(Electrode plate forming step)

The negative electrode in the form of a composite material configured of 92.5 parts by mass of artificial graphite coated with amorphous and 7.5 parts by mass of polyvinylidene fluoride was formed on a Cu foil.

The positive electrode, on the other hand, in the form of a composite material composed of 85 parts by mass of nickel lithium, 10 parts by mass of carbon black and 5 parts by mass of polyvinylidene fluoride was formed on an Al foil.

The electrolyte was configured of a solvent containing 3 parts by volume of ethylene carbonate and 7 parts by volume of diethyl carbonate in which 1 mol of LiPF₆ is dissolved per liter of solvent.

(Porous film attaching step)

Thirty parts by mass of saturated polyester (Vylon KS001 made by TOYOBO CO., Ltd.) and 6 parts by mass of triallyl isocyanurate were dissolved in 70 parts by mass of N-methyl pyrrolidone at 125° C. (S10) thereby to produce a polymer solution.

The polymer solution was coated on the separated film with die coater, and the resulting assembly was dipped in water for five minutes and dried, thereby producing a porous film on the separated film.

(Protection step)

The surface of the porous film facing the negative electrode of the porous film was dipped for one minute in a mixture solvent of LUMO=0.9 V and HOMO=10.7 eV, containing 5 parts by mass of γ-acryloxy propyl trimethoxy silane (KBM5103 made by Shin-Etsu Chemical Co., Ltd.), one part by mass of dicmyl peroxide (Percmyl D made by NOF CORPORATION), 5 parts by mass of water and 89 parts by mass of ethanol, and dried to remove the ethanol and water.

After that, this porous film was heat treated for three hours at 150° C. in N₂ thereby to produce a surface treated separator.

(Test)

A battery of type 18650 comprising the porous film, a positive electrode and a negative electrode was fabricated, and repeatedly charged and discharged at an atmospheric temperature of 60° C. with a constant current having the current density of 2.2 mA/cm².

(Reference 3)

(Electrode plate forming step)

The positive and negative electrodes were formed by similar steps to those of the fourth embodiment.

(Porous film attaching step)

Thirty parts by mass of saturated polyester (Vylon KS001 made by TOYOBO CO., Ltd.) and 6 parts by mass of triallyl isocyanurate were dissolved in 70 parts by mass of N-methyl pyrrolidone at 125° C. (S10) thereby to produce a polymer solution.

The polymer solution was coated on the separated film with die coater, and the resulting assembly was dipped in water for five minutes and dried, thereby producing a porous film on the separated film.

This porous film was dipped for one minute in a solvent composed of one part by mass of dicmyl peroxide (Percmyl D made by NOF CORPORATION) and 99 parts by mass of ethanol, and dried to remove ethanol.

After that, the porous film was heat treated for three hours at 150° C. in N₂.

(Test)

A battery of type 18650 comprising the porous film, a positive electrode and a negative electrode was fabricated, and repeatedly charged and discharged at the atmospheric temperature of 60° C. with a constant current having the current density of 2.2 mA/cm².

(Result)

After 500 charge/discharge cycles, the discharge capacity ratio was 74% for the embodiments, and 44% for the references. Thus, the use of a separator surface treated with γ-acryloxy propyl trimethoxy silane improved the service life.

[Porous film of non-aqueous electrolyte secondary battery]

(Embodiment 5)

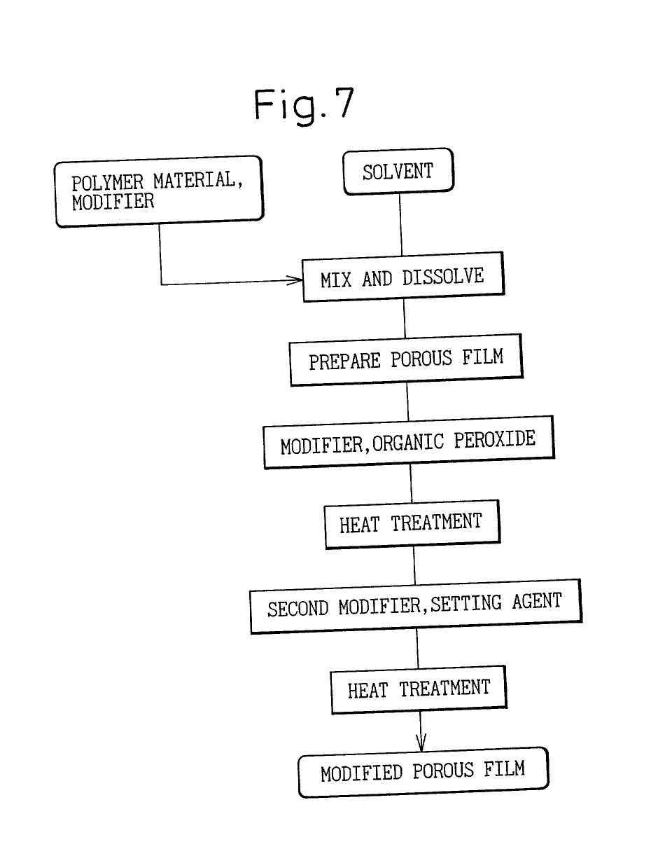

A porous film was prepared based on the process drawing of FIG. 7.

(Porous film forming step)

Thirty parts by mass of saturated polyester (Vylon KS021 made by TOYOBO CO., Ltd.) and 6 parts by mass of triallyl isocyanurate were dissolved in 70 parts by mass of N-methyl pyrrolidone at 130° C. thereby to produce a polymer solution.

The polymer solution was coated on a separated film with die coater, and the resulting assembly was dipped in water for five minutes and dried, thereby producing a porous film on the separated film.

(Modification step)

The porous film was separated from the separated film, and after being dipped for one minute in a mixture solution containing 5 parts by mass of γ-acryloxy propyl trimethoxy silane (KBM5103 made by Shin-Etsu Chemical Co., Ltd.), one part by mass of dicmyl peroxide (Percmyl D made by NOF CORPORATION), 5 parts by mass of water and 89 parts by mass of ethanol, dried to remove the ethanol and water. After that, the porous film was heat treated for three hours at 150° C. in N₂.

Further, the porous film with the surface modified as described above was dipped for one minute in a mixed solution of 5 parts by mass of organopolysiloxane (KR400 made by Shin-Etsu Chemical Co., Ltd.), 0.5 parts by mass of a setting catalyst (D20 made by Shin-Etsu Chemical Co., Ltd.) and 94.5 parts of a mixture solvent of xylene, isopropyl alcohol and butyl cellosolve (Thinner 6520 made by Ohashi Chemical Co., Ltd.), after which the solvent was removed. Then, the assembly was heat treated for one hour at 80° C. in the air.

(Embodiment 6)

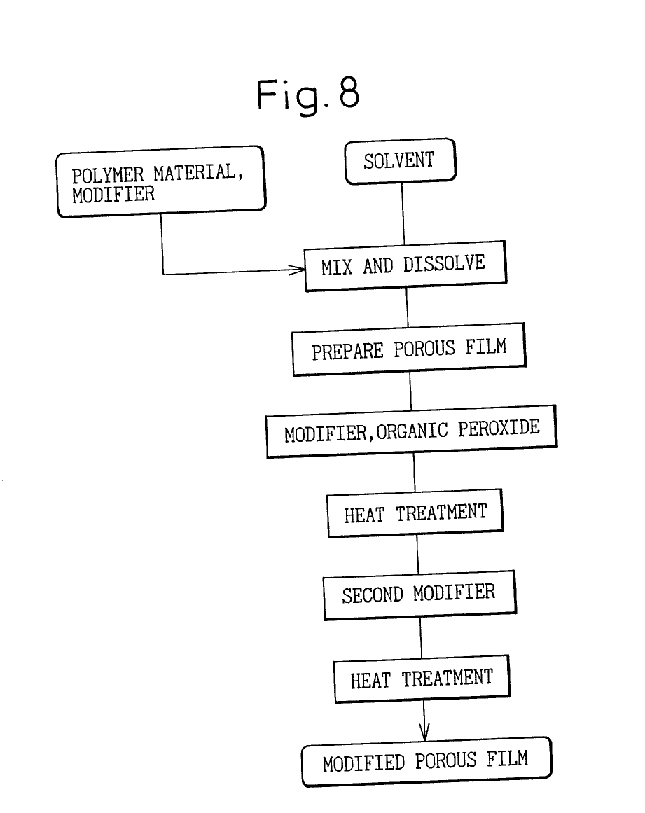

A porous film was prepared based on the process drawing of FIG. 8.

A porous film was prepared in a similar manner to the fifth embodiment (Porous film forming step).

(Modification step)

This porous film was separated from a separated film, and after being dipped for one minute in a mixture solution containing 5 parts by mass of γ-acryloxy propyl trimethoxy silane (KBM5103 made by Shin-Etsu Chemical Co., Ltd.), one part by mass of dicmyl peroxide (Percmyl D made by NOF CORPORATION), 5 parts by mass of water and 89 parts by mass of ethanol, dried to remove the ethanol and water. After that, the porous film was heat treated for three hours at 150° C. in N₂.

Further, the porous film with the surface thereof modified as described above was dipped for one minute in a mixture solution of 5 parts by mass of organopolysiloxane (KR400 made by Shin-Etsu Chemical Co., Ltd.), 5 parts by mass of pure water, and 90 parts by mass of ethanol, which mixture was allowed to stand and organopolysiloxane was hydrolyzed. After that, the ethanol and water were removed. Then, the assembly was heat treated for one hour at 120° C. in the air.

(Embodiment 7)

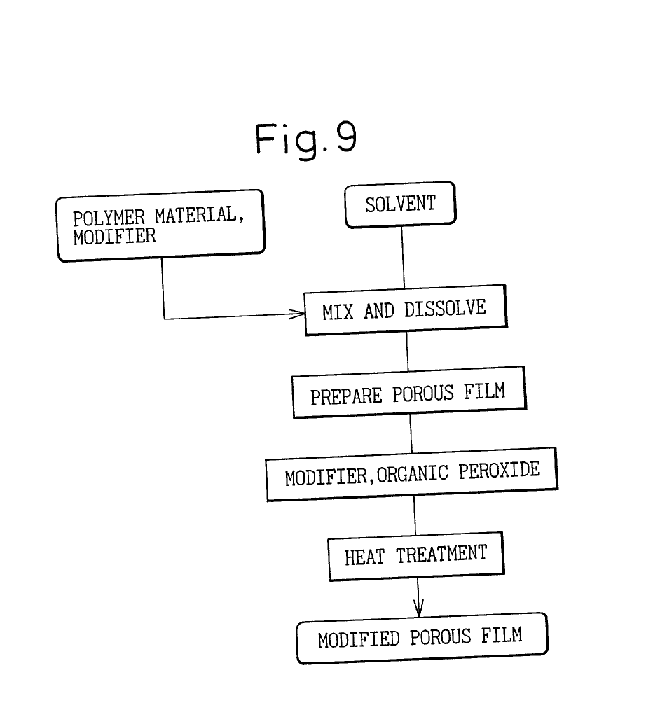

A porous film was prepared based on the process drawing of FIG. 9.

A porous film was prepared in a similar manner to the fifth embodiment (Porous film forming step).

(Modification step)

This porous film was separated from a separated film, and after being dipped for one minute in a mixed solution containing 5 parts by mass of γ-acryloxy propyl trimethoxy silane (KBM5103 made by Shin-Etsu Chemical Co., Ltd.), 5 parts by mass of organopolysiloxane (KR400 made by Shin-Etsu Chemical Co., Ltd.), one part by mass of dicmyl peroxide (Percmyl D made by NOF CORPORATION), 5 parts by mass of water and 84 parts by mass of ethanol, and dried to remove the ethanol and water. After that, the porous film was heat treated for three hours at 150° C. in N₂.

(Embodiment 8)

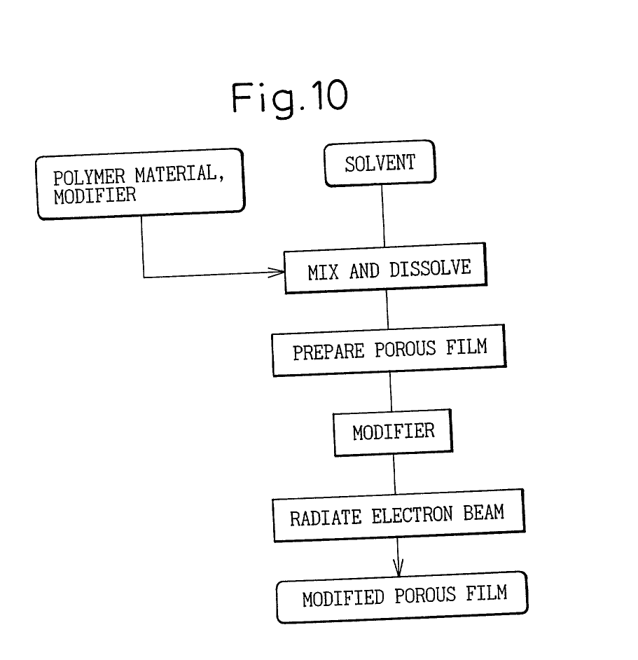

A porous film was prepared based on the process drawing of FIG. 10.

(Porous film forming step)

Thirty parts by mass of saturated polyester (Vylon KS021 made by TOYOBO CO., Ltd.) and 6 parts by mass of triallyl isocyanurate were dissolved in 70 parts by mass of N-methyl pyrrolidone at 130° C. thereby to produce a polymer solution.

The polymer solution was coated on a separated film with die coater, and the resulting assembly was dipped in water for five minutes and dried, thereby producing a porous film on the separated film.

(Modification step)

This porous film was separated from a separated film, and after being dipped for one minute in a mixture solution containing 5 parts by mass of γ-acryloxy propyl trimethoxy silane (KBM5103 made by Shin-Etsu Chemical Co., Ltd.), 5 parts by mass of organopolysiloxane (KR400 made by Shin-Etsu Chemical Co., Ltd.), 5 parts by mass of water and 85 parts by mass of ethanol, dried to remove the ethanol and water. After that, the porous film was irradiated with an electron beam of 500 kGy in N₂ and heat treated for one hour at 120° C. in the air.

(Embodiment 9)

An unwoven fabric formed by the melt-blow method from polybutylene telephthalate was processed in the modification step similar to that of the seventh embodiment.

(Reference 4)

A porous film of the fourth reference was prepared from the unwoven fabric of polybutylene telephthalate formed by the melt-blow method.

(Reference 5)

The unwoven fabric formed by the melt-blow method from polybutylene telephthalate was dipped for one minute in a mixture solution composed of 5 parts by mass of organopolysiloxane (KR400 made by Shin-Etsu Chemical Co., Ltd.) and 0.5 parts by mass of a setting catalyst (D20 made by Shin-Etsu Chemical Co., Ltd.) and 94.5 parts by mass of a mixture solution of xylene, isopropyl alcohol and butyl cellosolve (Thinner 6520 made by Ohashi Chemical Co., Ltd.), and the solvent was removed. After that, the assembly was heat treated for one hour at 80° C. in the air.

(Test for reduction resistance of simple cell)

The porous film of φ15 mm according to the fifth to ninth embodiments and the fourth and fifth references was held in Li metal of φ15 mm, and by injecting an electrolyte composed of a solution containing LiPF₆ of 1 mol/L in the ratio EC/EMC=50/50, was allowed to stand in a hermetic cell for 20 hours at 110° C. After that, the cell was decomposed and the area holding rate S/SO of the porous film was measured, where S is the projection area of the porous film after decomposition, and SO the initial projection area (1.77 cm²) of the porous film.

(Battery endurance test)

The porous film according to the fifth to ninth embodiments and the fourth and fifth references was used as a separator. As for the electrodes, on the other hand, the negative electrode was formed on a Cu foil as a composite material composed of 92.5 parts by mass of artificial graphite coated with amorphous and 7.5 parts by mass of polyvinylidene fluoride, while the positive electrode was formed on an Al foil as a composite material composed of 85 parts by mass of nickel lithium, 10 parts by mass of carbon black and 5 parts by mass of polyvinylidene fluoride. Also, the electrolyte was composed of a solvent containing 3 parts by volume of ethylene carbonate and 7 parts by volume of diethyl carbonate in which LiPF₆ was dissolved at the rate of 1 mol per liter of the solvent. A 18650 type battery comprising this separator and positive and negative electrodes was prepared, and repeatedly charged and discharged in 500 cycles at an atmospheric temperature of 60° C. with a constant current of 2.2 mA/cm² in current density.

(Result)

(Test for reduction resistance with simple cell)

The ratio S/SO after the test was about 30% for the fourth reference and about 50% for the fifth reference, which indicate that the degeneration has proceeded, while the figure was about 80% for the fifth embodiment, about 85% for the sixth embodiment, about 90% for the seventh embodiment, about 95% for the eighth embodiment and about 70% for the ninth embodiment. As seen, the figures were more than 70% for all the cases, and a remarkable improvement in the reduction resistance was achieved by the embodiments as compared with the references. It should be noted here that even the ninth embodiment, for which only the surface of the porous film was modified in simple way saw a considerable improvement in reduction resistance as compared with the porous film of the fourth and fifth references.

The foregoing test results show that, according to the embodiments, the polymer on the surface of the porous film was bonded with the modifier and further organopolysiloxane reacted with the modifier to form a highly durable —SiOSi— film on the surface layer.

In the fourth reference, on the other hand, a film was not formed on the polymer of the surface of the porous film. In the fifth reference, the linkage between the polymer of the surface of the porous film and organopolysiloxane is limited in such a manner that only the —OH— group and the —COOH— group of a part of the polymer and the —OH group of organopolysiloxane are dehydrated and condensed. Therefore, a sufficient reduction resistance was not probably achieved.

(Battery endurance test)

As a result of disassembling each battery after charge and discharge, it was found that the separator of the references interposed between the portion lacking the positive composite material (where a strong reduction atmosphere prevails) and the portion having the negative electrode composite material was partially swollen and dropped off. In the fifth to ninth embodiments, however, the separator was not swollen. Thus, a similar result to that of the test of reduction resistance with a simple cell described above was obtained.

As described above, according to this invention, there is provided a porous film for a non-aqueous electrolyte secondary battery by which a highly safe, inexpensive non-aqueous electrolyte secondary battery can be fabricated.

Also, according to this invention, there is provided method of fabricating a porous film of a non-aqueous electrolyte secondary battery by which a highly safe, inexpensive non-aqueous electrolyte secondary battery can be fabricated.

Further, according to this invention, there is provided a method of fabricating an electrode of a non-aqueous electrolyte secondary battery by which a highly safe, inexpensive non-aqueous electrolyte secondary battery can be fabricated.

Furthermore, according to this invention, there is provided an electrode of a non-aqueous electrolyte secondary battery by which a highly safe, inexpensive non-aqueous electrolyte secondary battery can be fabricated.

In addition, according to this invention, there is provided a highly safe, inexpensive non-aqueous electrolyte secondary battery.

What is claimed is:

1. A method of fabricating a porous film of a non-aqueous electrolyte secondary battery, comprising the steps of:
forming a porous film composed of a polymer material; and
modifying at least a portion of said porous film by bonding a predetermined substituent different from the group contained in said polymer material to the carbon atoms of the backbone chain of said polymer material through at least two successive carbon atoms in said predetermined substituent.

2. A method of fabricating a porous film of a non-aqueous electrolyte secondary battery, according to claim 1,
wherein said modification step is for causing a modifier having one to 100 parts by mass of said predetermined substituent to react with 100 parts by mass of said polymer material constituting said porous film.

3. A method of fabricating a porous film of a non-aqueous electrolyte secondary battery, according to claim 1,
wherein said porous film forming step is for forming a porous film using a mixture material of said polymer material and said modifier having said predetermined substituent.

4. A method of fabricating a porous film of a non-aqueous electrolyte secondary battery, according to claim 1,
wherein said modification step includes the step of coating said modifier having said predetermined substituent on the surface of said porous film, and
wherein a selected one of said predetermined substituent of said modifier and said backbone chain is bonded to said predetermined substituent after said coating step.

5. A method of fabricating a porous film of a non-aqueous electrolyte secondary battery, according to claim 1,
wherein said modification step includes the step of radiating a high-energy beam on said porous film thereby to bond a selected one of said predetermined substituent and said backbone chain to said predetermined substituent.

6. A method of fabricating a porous film of a non-aqueous electrolyte secondary battery, according to claim 1,
wherein said modification step includes the step of coating an initiator for starting the linkage between selected one of said predetermined substituent and said backbone chain and said predetermined substituent by heating said porous film, and the step of heating said porous film.

7. A method of fabricating a porous film of a non-aqueous electrolyte secondary battery, according to any one of claims 2 to 6,
wherein said modifier contains at least one compound having at least one polymerization group.

8. A method of fabricating a porous film of a non-aqueous electrolyte secondary battery, according to claim 7,
wherein said polymerization group is an unsaturated multiple bond.

9. A method of fabricating a porous film of a non-aqueous electrolyte secondary battery, according to any one of claims 2 to 6,
wherein said modifier is at least selected one of monoallyl isocyanurate, diallyl isocyanurate, triallyl isocyanurate, triallyl cyanurate, ethylene glycol di-{meth} acrylate, trimethyl propantri {meth}-acrylate, diallyl phthalate, divinyl benzene, vinyl toluene, vinyl pyridine, triallyl phthalate, vinyl trichlorosilane, vinyl tris (β-methoxy ethoxy) silane, vinyl triethoxy silane, vinyl trimethoxy silane, γ-({meth}-acryloxy propyl) trimethoxy silane, γ-({meth} acryloxy propyl) triethoxy silane, γ-({meth}-acryloxy propyl) methyl dimethoxy silane and acryl silicone.

10. A method of fabricating a porous film of a non-aqueous electrolyte secondary battery, according to claim 1,
wherein said polymer material is at least one of polybenzoimdazole, polyimide, polyether imide, polyamide imide, polyphenylene sulfide, polyether sulfone, polysulfone, polyether ether ketone, polymethyl pentene, aramide, polyvinylidene fluoride, polyamide, polyethylene telephthalate, polybutylene telephthalate, polyethylene naphthalate, polybutylene naphthalate, polyarylate, polyacetal and polyphenylene ether.

11. A method of fabricating a porous film of a non-aqueous electrolyte secondary battery, according to claim 7,
wherein said modifier is a compound having a LUMO energy value of not less than 0.3 eV with the polymerization group open.

12. A method of fabricating a porous film of a non-aqueous electrolyte secondary battery, according to claim 11,
wherein said modifier includes at least one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, vinyltris (β-methoxy ethoxy) silane, vinyl triethoxy silane, vinyltrimethoxy silane, γ-(acryloxy propyl) trimethoxy silane, γ-(methacryloxy propyl) trimethoxy silane, γ-(acryloxy propyl) triethoxy silane, and γ-(methacryloxy propyl) triethoxy silane.

13. A method of fabricating a porous film of a non-aqueous electrolyte secondary battery, according to claim 7,
wherein said modifier is a compound having a HOMO energy value of not more than −10.1 eV with the polymerization group open.

14. A method of fabricating a porous film of a non-aqueous electrolyte secondary battery, according to claim 13,
wherein said modifier includes at least one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, heptadecafluoro decylacrylate, heptadecafluoro decylmethacrylate, vinyltris (β-methoxy ethoxy) silane, vinyl triethoxy silane, vinyltrimethoxy silane, γ-(acryloxy propyl) trimethoxy silane, and γ-(acryloxy propyl) triethoxy silane.

15. A method of fabricating a porous film of a non-aqueous electrolyte secondary battery, according to claim 1, wherein said predetermined substituent has a —SiOSi— structure.

16. A method of fabricating a porous film of a non-aqueous electrolyte secondary battery, according to claim 1, further comprising the step of bonding said predetermined substituent to a second modifier having a —SiOSi— structure.

17. A method of fabricating the electrode of a non-aqueous electrolyte secondary battery, comprising the steps of:
forming an electrode plate providing a positive electrode or a negative electrode of said non-aqueous electrolyte secondary battery; and
attaching a porous film constituted of a polymer material on the surface of said electrode plate by forming said porous film on said surface of said electrode plate thereby to produce said electrode with a porous film formed thereon;
wherein said porous film attaching step includes the step of modifying at least a portion of said porous film by bonding a predetermined substituent different from the group contained in said polymer material to the carbon atoms of the backbone chain of said polymer material through at least two successive carbon atoms in said predetermined substituent after said porous film forming step.

18. A method of fabricating the electrodes of a non-aqueous electrolyte secondary battery, according to claim 17,
wherein said porous film forming step is for forming a porous film on the surface of said electrode plate by coating said polymer material in liquid state on the surface of said electrode plate.

19. A method of fabricating the electrodes of a non-aqueous electrolyte secondary battery, according to claim 17,
wherein said porous film forming step is for forming a porous film separate from said electrode plate, and
wherein said porous film attaching step includes the step of securely fixing said porous film on the surface of said electrode plate after said porous film forming step.

20. A porous film composed of a polymer material for a non-aqueous electrolyte secondary battery,
wherein at least a portion of said polymer material is modified by a predetermined substituent different from the group contained in said polymer material, said predetermined substituent having at least two successive carbon atoms bonded to the carbon atoms of the backbone chain of said polymer material.

21. A porous film of a non-aqueous electrolyte secondary battery, according to claim 20,
wherein a protective layer induced from the modifier having a LUMO energy value of not less than 0.3 eV is formed on the surface of said porous film with the polymerization group open.

22. A porous film of a non-aqueous electrolyte secondary battery, according to claim 21,
wherein said polymerization group is an unsaturated multiple bond.

23. A porous film of a non-aqueous electrolyte secondary battery, according to claim 21,
wherein said modifier includes at least one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, vinyltris (β-methoxy ethoxy) silane, vinyl triethoxy silane, vinyltrimethoxy silane, γ-(acryloxy propyl) trimethoxy silane, γ-(methacryloxy propyl) trimethoxy silane, γ-(acryloxy propyl) triethoxy silane, and γ-(methacryloxy propyl) triethoxy silane

24. A porous film of a non-aqueous electrolyte secondary battery, according to claim 20,
wherein a protective layer induced from the modifier having a HOMO energy value of not more than −10.1 eV is formed on the surface of said porous film with the polymerization group open.

25. A porous film of a non-aqueous electrolyte secondary battery, according to claim 24,
wherein said polymerization group is an unsaturated multiple bond.

26. A porous film of a non-aqueous electrolyte secondary battery, according to claim 24,
wherein said modifier includes at least one of ethylene glycol dimethacrylate, trimethyrol propane trimethacrylate, cyclohexyl methacrylate, octafluoro pentyl acrylate, octafluoro pentyl methacrylate, tetrafluoro propyl acrylate, tetrafluoro propyl methacrylate, heptadecafluoro decylacrylate, heptadecafluoro decylmethacrylate, vinyltris (β-methoxy ethoxy) silane, vinyl triethoxy silane, vinyltrimethoxy silane, γ-(acryloxy propyl) trimethoxy silane, and γ-(acryloxy propyl) triethoxy silane.

27. A porous film of a non-aqueous electrolyte secondary battery, according to claim 20,
wherein said predetermined substituent has a —SiOSi— structure.

28. A porous film of a non-aqueous electrolyte secondary battery, according to claim 20,
wherein said predetermined substituent is bonded to a second modifier having a —SiOSi— structure.

29. An electrode of a non-aqueous electrolyte secondary battery, comprising:
an electrode plate providing a positive electrode or a negative electrode for the non-aqueous electrolyte secondary battery; and
a porous film configured of a polymer material and integrally formed on said electrode plate with at least selected one of the backbone chain of said polymer material modified by a predetermined substituent different from the group contained in said polymer material.

30. A non-aqueous electrolyte secondary battery, comprising an electrode unit including a positive electrode and a negative electrode stacked one on the other through a separator,
wherein said separator is selected one of the porous film fabricated by the method of fabricating a porous film of non-aqueous electrolyte secondary battery according to any one of claims 1 to 16 and the porous film of a non-aqueous electrolyte secondary battery according to claim 20.

31. A non-aqueous electrolyte secondary battery, comprising an electrode unit including a positive electrode and a negative electrode stacked one on the other,
wherein selected one of said positive electrode and said negative electrode is selected one of the electrode fabricated by the method of fabricating a non-aqueous electrolyte secondary battery according to any one of claims 17 to 19 and the electrode of a non-aqueous electrolyte secondary battery according to claim 29.
